(19) United States
(12) Patent Application Publication
(10) Pub. No.: US 2017/0230207 A1
(43) Pub. Date: Aug. 10, 2017

(54) METHODS FOR CREATING AND RECEIVING MULTI-CARRIER SIGNALS. CODIFICATION, COMMUNICATION AND DETECTION APPARATUS. TUNABLE NOISE-CORRECTION METHOD FOR OVERLAPPED SIGNALS. ITERATIVE ESTIMATION METHOD FOR OVERLAPPED SIGNALS

(71) Applicant: Fausto D. HOLGUIN-SANCHEZ, Irvine, CA (US)

(72) Inventor: Fausto D. HOLGUIN-SANCHEZ, Irvine, CA (US)

(21) Appl. No.: 15/127,357

(22) PCT Filed: Mar. 19, 2014
(86) PCT No.: PCT/US14/31143

§ 371 Date: Sep. 19, 2016

Related U.S. Application Data
(60) Provisional application No. 61/802,495, filed on Mar. 16, 2013.

(51) Int. Cl. H04L 25/03; H04L 25/06; H04L 5/00

(52) U.S. Cl. CPC H04L 25/03159; H04L 5/001; H04L 25/067

(57) ABSTRACT

A spectrally efficient multi-carrier communication apparatus with advanced features of carrier management. The apparatus is flexible to changes in the form of the sub-carrier and their location in frequency. This invention can use non-standard pulses at arbitrary frequencies providing a greater control of the carrier. The additional features can be used for spectral efficiency, to correct signal distortion or for privacy. Also disclosed is a novel multiplexing method that saves spectrum called Spectral Shape Division Multiplexing (SSDM), preferred embodiments of the transmitter and receiver. Two complementary algorithms help the invention excel among other existent methods. The disclosed algorithms can similarly be adapted to other systems. A correction method for spectrally efficiency is calibrated to all desired noise levels for maximum benefit. An iterative multi-carrier reduction method dramatically reduces the error on overlapped subcarriers.

### CROSS-REFERENCE TO RELATED APPLICATIONS

This application claims the benefit of provisional patent application Ser. No. 61/802,495, filed 2013 Mar. 16 by the present inventor.

### FIELD OF THE INVENTION

The present invention and methods relate to communications systems, and more particularly, this invention and methods relate to multiple carrier communications systems, including but not limited to the called Spectral Shape Division Multiplexing (SSDM), Spectrally Efficient Frequency Division Multiplexing (SEFDM), Overlapped Frequency Division Multiplexing (OVFDM), Orthogonal Frequency Division Multiplexing (OFDM), Non Orthogonal Frequency Division Multiplexing (NOFDM), Frequency Division Multiplexing (FDM), and other uses of SSDM.

### PRIOR ART

S. C. Carroll. Non-orthogonal frequency-division multiplexed communication through a non-linear transmission medium. patent, December 2010. U.S. Pat. No. 7,852,745.
S. Rongfang. Method for suppressing the inter-carrier interference in the OFDM mobile system. patent, November 2008. US 2008/0304585 A1.
S. I. A. Ahmed. Spectrally Efficient FDM Communication Signals and Transceivers: Design, Mathematical Modeling and System Optimization. PhD thesis, University College London, Communications and Information Systems Research Group, October 2011.
D. Li. Method and system of frequency division multiplexing. patent, March 2011. US 2011/0075649 A1.
H. Fujii. OFDM receiver. patent, June, 2005. US 2005/0129136 A1.
L. Wilhelmsson. Low complexity Inter-carrier interference cancellation. patent, April, 2010. U.S. Pat. No. 7,706,428 B2.
X. Zhang. Iterative channel estimation method and apparatus for ICI cancellation in multi-carrier. patent February, 2013. U.S. Pat. No. 8,374,266 B2.
M. Stojanovic. Method of non-uniform Doppler compensation for wide-band OFDM signals. patent November, 2010. U.S. Pat. No. 7,844,006 B2.
M. Yoshida. Receiver which demodulates OFDM symbol. patent September, 2004. US 2004/0184550 A1.
S. Bharadwaj, B. NithinKrishna, V. Sutharshun, P. Sudheesh, and M. Jayakumar. Low complexity detection scheme for NOFDM systems based on ml detection over hyperspheres. In Devices and Communications (ICDeCom), 2011 International Conference on, pages 1-5, February 2011.
R. Clegg, S. Isam, I. Kanaras, and I. Darwazeh. A practical system for improved efficiency in frequency division multiplexed wireless networks. Communications, IET, 6(4):449-457, June 2012.
R. Grammenos, S. Isam, and I. Darwazeh. Fpga design of a truncated SVD based receiver for the detection of SEFDM signals. In Personal Indoor and Mobile Radio Communications (PIMRC), 2011 IEEE 22nd International Symposium on, pages 2085-2090, September 2011.
S. Isam and I. Darwazeh. Precoded spectrally efficient FDM system. In Personal Indoor and Mobile Radio Communications (PIMRC), 2010 IEEE 21st International Symposium on, pages 99-104, September 2010.
S. Isam and I. Darwazeh. Design and performance assessment of fixed complexity spectrally efficient FDM receivers. In Vehicular Technology Conference (VTC Spring), 2011 IEEE 73rd, pages 1-5, May 2011.
S. Isam, I. Kanaras, and I. Darwazeh. A truncated SVD approach for fixed complexity spectrally efficient FDM receivers. In Wireless Communications and Networking Conference (WCNC), 2011 IEEE, pages 1584-1589, March 2011.
W. Jian, Y. Xun, Z. Xi-lin, and D. Li. The prefix design and performance analysis of DFT-based overlapped frequency division multiplexing (OVFDM-DFT) system. In Signal Design and Its Applications in Communications, 2007. IWSDA 2007. 3rd International Workshop on, pages 361-364, September 2007.
I. Kanaras. Spectrally Efficient Multicarrier Communication Systems: Signal Detection, Mathematical Modeling and Optimization. PhD thesis, University College London, Communications and Information Systems Research Group, June 2012.
I. Kanaras, A. Chorti, M. Rodrigues, and I. Darwazeh. Investigation of a semidefinite rogramming detection for a spectrally efficient FDM system. In Personal, Indoor and Mobile Radio Communications, 2009 IEEE 20th International Symposium on, pages 2827-2832, September 2009.
I. Kanaras, A. Chorti, M. Rodrigues, and I. Darwazeh. Spectrally efficient FDM signals: Bandwidth gain at the expense of receiver complexity. In Communications, 2009. ICC '09. IEEE International Conference on, pages 1-6, June 2009.
I. Kanaras, A. Chorti, M. Rodrigues, and I. Darwazeh. A fast constrained sphere decoder for ill conditioned communication systems. Communications Letters, IEEE, 14(11):999-1001, November 2010.
S. Pagadarai, A. Kliks, H. Bogucka, and A. Wyglinski. On non-contiguous multi-carrier waveforms for spectrally opportunistic cognitive radio systems. In Waveform Diversity and Design Conference (WDD), 2010 International, pages 000177-000181, August 2010.
Y. Sun, H. Wang, and Y. Zhang. Fast detection algorithm based on sphere decoding for overlapped hybrid division multiplexing system. In Future Computer and Communication (ICFCC), 2010 2nd International Conference on, volume 1, pages V1-277-V1-280, May 2010.

### BACKGROUND OF THE INVENTION

Frequency bands are an expensive and a limited resource subject to a greater demand everyday. Because of this, the capacity of wireless networks becomes rapidly exhausted in congested areas. To maintain the quality of service in zones that show high demand, Telco companies take actions to maintain the tradeoff between capacity and coverage. One of the actions is deploying additional wireless infrastructure to recycle assigned frequencies using smaller coverage areas. Another action, not always feasible because of the dearth of available bands, is to buy more licenses to use additional radioelectric spectrum. Both of those options are expensive. Billions of dollars are invested in licenses to use the wireless spectrum. Similarly, the communications industry spends billions to upgrade both wireless networks and external plant every year.

As a solution to this problem, the present invention is a spectrally efficient system that can increase the Effective Spectral Efficiency (ESE) in wireless and wired communications when compared with Orthogonal Frequency Division Multiplexing (OFDM). Among other possible uses of the invention there is decoding multi-carrier signals affected by the Doppler effect, using special and/or dynamic pulse patterns for privacy, encoding bits into private PCM code or reduction of interference from surrounding carriers.

Spectral shape division multiplexing (SSDM) is a modulation method that can both optimize the utilization of the scarce radioelectric spectrum and increase the data throughput. Similar to OFDM, multiple sub-carriers can be used to evenly distribute information across an allocated bandwidth. However, SSDM also allows these sub-carriers to be non-orthogonal, allowing more carriers per designated bandwidth. The initial tradeoff of using non-orthogonal carriers is higher Bit-Error Rate (BER) for a certain Signal-to-Noise Ratio (SNR). Nevertheless, certain configurations allow maintaining the SNR levels with increased sampling rate thus computation. Despite higher BER, it is shown that SSDM out-performs OFDM and other modulation techniques in effective spectral efficiency (ESE), which is defined as the number of successful bits per second per Hertz that can be achieved. Nonetheless the bit-error rate drops dramatically at the receiver by using either or, even better, both of the complementary correction methods included in this disclosure.

Describing the basic capabilities in brief terms, SSDM encodes a plurality of sub-carrier signals with arbitrary pulse shape that form a base of signal patterns. Similar than OFDM, SSDM codifies words of information called symbols. One of the greatest features of SSDM is that every sub-carrier can be assigned a certain modulation frequency and be independently modified by an arbitrary unique Quadrature-Amplitude-Modulation (QAM) constellation. An important requirement for SSDM is that every sub-carrier should have a unique, linearly independent, pulse shape. Reciprocally, this is equivalent to say that every sub-carrier should have a unique linearly independent spectral shape. The pulse patterns could either be homogeneous tones that are equally spaced in frequency across all sub-carriers as shown in FIG. 2. Nonetheless, the pulse patterns could also be formed by modified non-standard tones as seen in FIG. 3, for instance windowed or modulated, non homogeneously spaced across the frequency spectrum, or any combination of them. In a certain embodiment, the base patterns used to compute the projection matrix, stored in the projection matrix memory [43] and computed by Eq. 14, could change from time to time either for several reasons including privacy, dynamically adapting to a varying Doppler effect, to adapt to a varying channel transfer function or to relocate the sub-carrier frequencies. The SSDM system disclosed in this invention provides the flexibility to adapt to those conditions in a practical manner meanwhile offering potential benefits of throughput and spectral efficiency. In a certain embodiment, the frequencies, order and number of sub-carriers can change upon a mechanism of Medium Access Control such as currently performed with OFDM in a variety of systems such as LTE, WiFi or WiMax.

Regarding the name assigned to the multiplexing method herein disclosed, Spectral Shape Division Multiplexing, means that it multiplexes streams of information by assigning unique spectral forms to every stream. Other names that could represent the same purpose are Signal Shape Division Multiplexing, Linearly Independent Signal Division Multiplexing, Shared Spectrum Multiplexing or Pulse Shape Division Multiplexing. The SSDM name seems to represent the disclosed method better while, at the same time, is consistent with the theoretical foundations of the invention. On the other hand, authors of prior art have taken different paths calling spectral efficient methods Spectrally Efficient Frequency Division Multiplexing (SEFDM), Non OFDM (NOFDM) or Overlapped FDM (OvFDM)—they all introducing very different receiving and transmitting mechanisms. Similarly, the great majority of prior art uses tones that are equally spaced in the frequency domain to compose the multi-carrier signal being always homogeneous and having a fixed spectral shape. Therefore, the name of SSDM seems to fit the method better due to the ability to work while varying the frequency steps arbitrarily and the pulse shape of individual sub-carrier at the convenience of the user.

With minimum hardware changes with respect to OFDM, the SSDM system is designed to be backwards compatible with existent technologies such as OFDM, FDM, SEFDM, OvFDM, an others. Additionally, to implement OFDM, a changes are introduced to the OFDM modems. In one embodiment, as shown in FIG. 6, these changes are the inclusion of a memory with off-line pre-computed samples of signal patterns in both In-phase and in-Quadrature for I-Q modulation, and an adder. In this embodiment, the cyclic pre-fix (CP), as used in OFDM to prevent multi-path distortion, can be included by making the signal patterns in memory longer. Different than an OFDM transmitter, in this embodiment, there is no Inverse Fast Fourier Transform (IFFT) block. At the receiver end, changes with respect to OFDM include, higher sampling rates and a matrix multiplication block of at least the same number of sub-carriers—similar to the existent units on prior art intended to reduce ICI. If using the benefit of the CM method, another multiplier and memory for coefficients is necessary. Meanwhile for the ILR method, an iterative process, additional buffers for matrix operations are necessary.

Besides the SSDM method of multiplexing information and modulating signals in this disclosure, the invention also encompasses apparatus for both transmission and reception of the information. A transmission apparatus can generate the sub-carrier signals in both analog or digital forms. Similarly, at the receiving end, embodiments with and without correction methods are shown, as well as the respective results. In addition to that disclosure and the suggested embodiments, two additional methods or algorithms are disclosed. These methods increase dramatically the performance of the SSDM system. The benefits of these methods overcome by far the additional amount of computation necessary to implement them. The first of the aforementioned methods, is a Correction Method (CM) at the receiver that can reduce BER and that can be pre-computed off-line for specific values of signal-to-noise-ratio (SNR). Meanwhile, the second method, name Iterative Lock and Reduce (ILR) brings additional advantages reducing the BER of the SSDM system by correcting a effect called ill-condition that is known to affect spectrally efficient and overlapped frequency methods. The ill-condition deteriorates the quality of the sub-carriers in the middle of the multi-carrier spectrum which suffer from unavoidable accumulated interference form the surrounding sub-carriers. The ILR method deals with this problem bringing outstanding results, when combined with proper equalization or no equalization is required, bringing equity and quality across all the sub-carriers.

A possible embodiment for communications consists of an apparatus with an SSDM transmitter and an SSDM receiver intended for communication systems. The transmitter possesses the capability of forming multiplexed signals for communications that are affected by a group of bits and a QAM constellation of corresponding order. The receiver has the ability to decode a composite signals that correspond to the superposition of individual signals. The invention includes a detection process that can be used along with the receiver to decouple interfering signals based on their individual properties such as pulse shape or spectral form. The signals detected by the receiver could be SSDM wireless signals but also legacy technologies such as FDM signals, OvFDM signals, OFDM signals, NOFDM signals and, in general, a signal that could come from a sensor/transducer that comprises of many superposed signals due to the nature of the measurements, or from the environment such as the superposition of several sound waves or other type of waves. The SSDM apparatus can also operate with CDMA signals since despite all subcarriers have the same frequency, they all have a different orthogonal pattern. The receiver in this invention has the ability to approximate the signal to the closest matching combination of signal patterns. The module that performs the approximation is called a detector. Other inventions and improving methods could complement this invention to improve or modify the detection process. A possible embodiment for security or simple codification would consist on assigning an SSDM receiver to process signals by assigning secret signal patters on the receiver. The SSDM receiver can also be used to decode signals which are the composite of sub-signals with well know pulse or frequency patterns. The patterns utilized for the codification can be kept secret and can be used for decodification. The invention has the ability to approximate the signal to the closest matching combination of signal patterns. The module that performs the approximation is called a detector. Other inventions and can be used to improve the detector. The encoded information can be processed by an SSDM transmitter with matching or close patterns. The output signal form the SSDM transmitter construes an approximation to the decoded signal. If a linear combination of the modulated signal patterns comprise all the content of the signal, the amount of the information of the signal can be reduced once encoded. This is similar to the size of the information to represent one note as compared with the sound file of the note being played on a synthesizer.

In conclusion, SSDM allows arbitrary frequency steps enabling higher spectral efficiency and flexibility than OFDM and other spectrally efficient methods. Similarly, while other methods use sinusoidal pulse forms, SSDM can use non-standard pulses providing a greater control of the carrier for privacy and endurance. The SSDM transceiver can be implemented to reduce the spectrum utilization which according to the configuration presents an increase in spectral efficiency of 50% average with respect to OFDM with slight architectural upgrades and some nowadays affordable computational expense. The correction methods CM and ILR herein disclosed are not limited to SSDM but applicable for other decoders.

### OBJECTS OF THE INVENTION

The system and methods disclosed in this invention bring several advantages.

The SSDM method: A great benefit of SSDM is the ability to modulate and demodulate non uniform carriers and arbitrary frequency steps. This provides greater maneuverability of the carriers. Additionally, SSDM has the inherent ability to decode several carriers at once and to decode signals after windowing with practically no increment in the complexity of the receiver.

High Spectral Efficiency (SE): The cost to achieve reduced spectrum utilization with SSDM is higher SNR than OFDM, the addition of a detection block at the receiver, higher sampling frequencies and longer Fourier transform blocks. In other words, a more powerful architecture is required in comparison with OFDM. Despite of this, it is seen that the SSDM system is in many ways less complex than other SE methods seen in prior art.

The sub-carriers are not limited to tones: The SSDM system can use different types of signals in different sub-carriers. This provides flexibility for a variety of applications and allows to deal technical communication challenges. For instance, communications can be kept private at the physical layer when using signals and frequencies that are unknown to other users. Similarly, the use of compressed tones could compensate for issues with the linearity of the amplifier at the transmitter, or the use of equalized sub-carrier signals at the receiver could compensate for channel distortion.

The sub-carriers can be arranged at non homogeneous frequency steps: This brings higher flexibility to the apparatus. The ability of transmitting or receiving in arbitrary frequency steps can be used to accommodate more sub-carriers in sections of the spectrum where the channel proofs favorable. Also, this feature can be used for privacy.

Both the transmitter and receiver architecture are feasible with simple changes to current systems: The architecture of this invention is just as realizable as other systems currently available. Possible upgrades to current systems involve faster sampling rates. Similarly, faster sampling rates at the receiver and slight changes to the Fourier transform blocks are the most notorious with respect to OFDM systems. Nevertheless, the addition of memory blocks for coefficients and signal generators, adders, matrix multipliers and computational stages, are currently part of prior art such as in OFDM systems with ICI cancellation.

Backwards compatible with other systems: With the appropriate selection of signal base patterns, the SSDM system disclosed in this invention can operate as in FDM, CDMA, OFDM and other SEFDM systems. This makes the SSDM system highly attractive for compatibility with legacy systems plus the ability to use the advantages of each at any point.

It can decode OFDM with ICI due to Doppler: This invention can communicate with OFDM systems by pre-modulate and demodulating signals affected with the Doppler effect. As for the SSDM system, an OFDM signal distorted by Doppler is no different than an SEFDM signal, therefore there is inherent support for this type of signals. The SSDM system requires the signal coefficients to be computed by an estimation stage not part of this system.

The invention can be used to reduce the noise floor of a carrier when this is determined by surrounding carriers: Due to the ability of SSDM to include sub-carriers at arbitrary frequency steps, synchronized sub-carriers corresponding to communications in adjacent channels can be included in the detector as additional sub-carriers. The resultant effect in tests is that the side lobes from adjacent channels, which usually acts as Inter-Channel-Interference, becomes additional information that contributes to decoding of the signal of interest with reduced BER when the surrounding channels are synchronized.

It has been shown that SSDM displays higher throughput than OFDM. Under certain conditions, SSDM also has a decreased BER and higher ESE, as defined in Eq. 20, than other SE methods. Depending on the carrier dimensionality, the increase in throughput can roughly be 50% more than OFDM and 30% more than known SE methods with a thousand times less error likelihood. High dimensional carriers however require the leverage on other techniques for an efficient reception.

### BRIEF DESCRIPTION OF THE DRAWINGS

For a more complete understanding of the invention, reference is made to the following description and accompanying drawings, in which:

FIG. 1 is an OFDM transmitter and an OFDM receiver;

FIG. 2 is a multi-carrier signal with homogeneous frequency steps and uniform sub-carrier tones;

FIG. 3 is a multi-carrier signal with arbitrary frequency steps and non uniform sub-carrier signals;

FIG. 4 is a Shared Spectrum Division Multiplexing communications system;

FIG. 5 is an embodiment of a SSDM receiver;

FIG. 6 is a general embodiment of a SSDM transmitter;

FIG. 7 is an embodiment of a SSDM transmitter for fixed sinusoidal sub-carriers;

FIG. 8 is a diagram exhibiting how one output of the detector is connected to the classifier;

FIG. 9 is an embodiment showing how one SSDM sub-carrier is generated, by scaling samples from memory, and aggregated to for the multi-carrier signal;

FIG. 10 is an embodiment for signal generation of a Spectrally Efficient signal by using a Sparse Inverse Fourier Transform block;

FIG. 11 is an embodiment of a configuration for data collection to generate a correction matrix for the Correction Method;

FIG. 12 is a flow diagram of the process to create a Correction Matrix;

FIG. 13 is an embodiment using a Correction Method to reduce errors in overlapped carrier detection;

FIG. 14 is a comparison of the output of a detector with and without the CM;

FIG. 15 is a figure exhibiting the multi-carrier reduction of the Iterative Lock and Reduction method;

FIG. 16 is a flow diagram of the iterative Lock and Reduction method;

FIG. 17 is a graphic of α vs BER vs signal strength in an SSDM embodiment system with QPSK and 12 sub-carriers without any correction methods, 12 sub-carriers with QPSK, symbol time of 3.2 μs, first carrier at IF of 40 MHz and f_{S}=1.28 GHz; and

FIG. 18 is a graphic of several calibrations of CM vs BER vs signal strength on a SSDM embodiment with ILR, α=0.5, 16 sub-carriers with 16-QAM and symbol time of 3.2 μs.

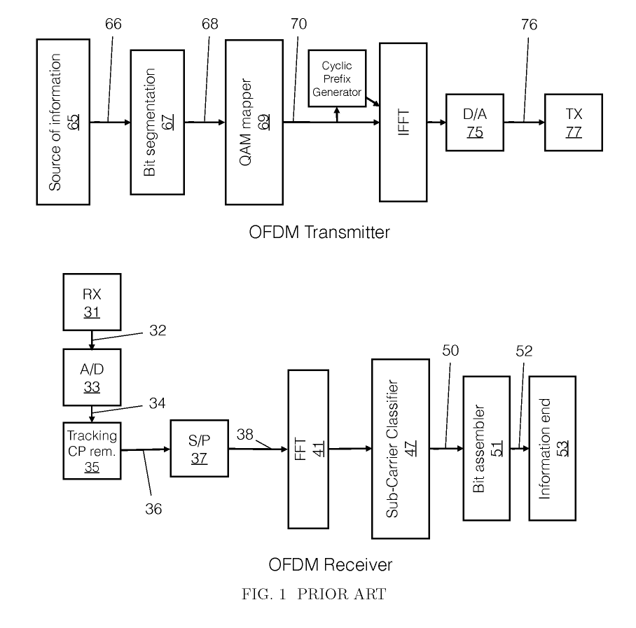

### SUMMARY OF THE INVENTION

Similar to OFDM, SDDM is a digital multicarrier able to spread high bit rate streams into lower rate subcarriers. Low rate signals are narrowband and therefore less sensitive to frequency selective channels. Besides that, the techniques used to give the SSDM carrier a certain endurance in the wireless channel can be taken from OFDM. For instance, the symbol time T can be extended to include a guard interval or cyclic prefix/postfix (CP) to prevent multipath propagation inter symbol interference (ISI). Finally, in SSDM the subcarriers pulses are not necessarily sinusoidal nor orthogonal. SSDM can use any sub-carrier overlapping and type of pulse. OFDM, SEFDM and OvFDM are particular cases of SSDM.

The SSDM system requires certain samples and coefficients stored in memory for proper operation. There are many ways to compute these values. This disclosure includes an analytical method and a numerical method, both of them comprising on computing the spectral representation of the desired sub-carrier signals. While the analytical method requires certain complex theoretical development, the numerical analysis is quicker when using a computer. In this sense, both of the methods are disclosed for convenience.

The numerical method to compute the projection matrix [43] at the receiver [30] consists of selecting the frequency bins of interest from the Fourier transform of the signals patterns to be used in each sub-carriers of the SSDM system. The respective case for an embodiment using sinusoidal sub-carriers would figure as follows, as latter shown in Eq. 14:

∀sub-carrierᵢ

For column i:

S_{C}(i,:)={\sqrt{2}×T_{S}×F({padding}, {cos(2·π·fᵢ)·t+π/4}, {padding})}, where padding is an arbitrary number of zeroes, to increase the accuracy of the results, t is a vector with the timestamp of each sample at the target sampling frequency f_{S} of the system, and S_{C} is an intermediate matrix corresponding to Eq. 12. The projection matrix Γ is then formed by selecting only N rows of interest, where N is the number of sub-carriers in the system. Other columns can be discarded. For best results select the rows associated to the frequency bins at the center frequency of the each of the sub-carriers or, in any case, frequency bins that have a strong energy component of the sub-carrier.

The matrix projection for some sub-carriers with forms derived from sinusoidal tones, such as windowed sinusoids, can also be computed with this method. For this, it is important to keep the rotation of π/4 and the scaling factor of \sqrt{2} to warranty a projection of normalized amplitude of 1 in both the real and imaginary components once projected onto the projection matrix Γ, which is part of the disclosed method herein. The amplitude of the received symbols requires being normalized by the receiver unit [31].

One particularity, and benefit, of the method, in a certain embodiment, is that more than N frequency bins can be selected to detect the SSDM carrier. This requires an extra output of the Sparse Fourier Transform performed in [41] as shown in FIG. 5. The SSDM receiver requires that the number of complex output values in [41] match with the dimension of the Projection Matrix [43].

Now, the analytical method is summarized. This method is recommended when using sub-carrier pulses other than sinusoidal. To configure the SSDM as a SE system, the SSDM is initially developed using sinusoidal subcarrier signals uniformly distributed in the frequency domain.

An SSDM carrier comprises of N subcarriers with arbitrary pulse shapes. The only condition is that the signals for different subcarriers need to be linearly independent. A formula derivation to for the SSDM transceiver can be done upon the selection of the pulse-set also called the basis signals. In this section, the formula is derived assuming standard RF pulses based on pure frequencies.

Let the SSDM carrier be encompassed of subcarriers at frequencies fᵢ, where i is the number of subcarrier 0, . . . , N−1, with average separation Δf=f_{N-1}−f₀/N−1 or α=Δf·T where α is the normalized subcarrier separation. If using standard RF pulses for the subcarriers rᵢ(t)=cos(2πfᵢ), the continuous function of the signals is given by

$${s}_{i} ( t ) = \{ \begin{matrix}{A}_{i} cos ( 2 π {f}_{i} t + {φ}_{i} ) & - T / 2 \leq t \leq T / 2 \\ 0 & otherwise\end{matrix}$$

during the symbol period T, where Aᵢ and φᵢ are the modulation parameters from the QAM constellation map Qᵢ. The constellation parameters represent the symbol sent on the subcarrier sᵢ(t). The composite SSDM carrier signal responds to the linear superposition of the children

$$s ( t ) = {\sum }_{i = 1}^{N} {s}_{i} ( t ) . \qquad ( 1 )$$

Due to the linearity property of the Fourier transform (for simplicity and clarity, ω replaces 2πf),

$$\begin{matrix}ℱ \{ s ( t ) \} = ℱ \{ {\sum }_{i = 1}^{N} {s}_{i} ( t ) \} \\ = {\sum }_{i = 1}^{N} ℱ \{ {s}_{i} ( t ) \} \\ S ( ω ) = {\sum }_{i = 1}^{N} {S}_{i} ( ω ) .\end{matrix} \qquad ( 2 )$$

But Sᵢ(ω) is given by

$$\begin{matrix}\begin{matrix}{S}_{i} ( ω ) = {\int }_{- ∞}^{∞} {s}_{i} ( t ) {e}^{- j ω t} dt \\ = {\sum }_{- T / 2}^{T / 2} {A}_{i} cos ( {ω}_{i} t + {φ}_{i} ) {e}^{- j ω t} dt \\ = {A}_{i} {\int }_{- T / 2}^{T / 2} \frac{{e}^{j ( {ω}_{i} t + {φ}_{i} )} + {e}^{- j ( {ω}_{i} t + {φ}_{i} )}}{2} {e}^{- j ω t} dt \\ = {A}_{i} {e}^{j {φ}_{i}} \frac{sin [ ( {ω}_{i} - ω ) T / 2 ]}{{ω}_{i} - ω} + {A}_{i} {e}^{- j {φ}_{i}} \frac{sin [ ( {ω}_{i} + ω ) T / 2 ]}{{ω}_{i} + ω} \\ = {A}_{i} cos {φ}_{i} \cdot ( \frac{sin [ ( {ω}_{i} - ω ) T / 2 ]}{{ω}_{i} - ω} + \frac{sin [ ( {ω}_{i} + ω ) T / 2 ]}{{ω}_{i} + ω} ) + \\ {jA}_{i} sin {φ}_{i} \cdot ( \frac{sin [ ( {ω}_{i} - ω ) T / 2 ]}{{ω}_{i} - ω} - \frac{sin [ ( {ω}_{i} + ω ) T / 2 ]}{{ω}_{i} + ω} ) \\ ⇒ {S}_{i} ( ω ) = {A}_{{R}_{i}} {B}_{R} ( {ω}_{i} , ω ) + {jA}_{{I}_{i}} {B}_{I} ( {ω}_{i} , ω )\end{matrix} & ( 3 ) \\ where & \\ {A}_{{R}_{i}} = {A}_{i} cos ( {φ}_{i} ) , {A}_{{I}_{i}} = {A}_{i} sin ( {φ}_{i} ) and & \\ {B}_{R} ( {ω}_{i} , ω ) = \frac{sin [ ( {ω}_{i} - ω ) T / 2 ]}{{ω}_{i} - ω} + \frac{sin [ ( {ω}_{i} + ω ) T / 2 ]}{{ω}_{i} + ω} & ( 4 ) \\ {B}_{I} ( {ω}_{i} , ω ) = \frac{sin [ ( {ω}_{i} - ω ) T / 2 ]}{{ω}_{i} - ω} - \frac{sin [ ( {ω}_{i} + ω ) T / 2 ]}{{ω}_{i} + ω} . & \end{matrix}$$

The functions B_{R}(ωᵢ,ω) and B_{I}(ωᵢ,ω) in Eq. 4 are both real and correspond to the normalized real and imaginary components of the spectrum of subcarrier i. These sync-like functions vary depending on T and ωᵢ. As expected according to the properties of the Fourier transform, the real component B_{R}(ωᵢ,ω) presents even symmetry while the imaginary component B_{I}(ωᵢ,ω) is odd. The weighted complex combination of the functions can generate the spectrum of any symbol as indicated in Eq. 3. The weighting factors are the elements from the QAM constellation A_{R}_{ᵢ} and A_{I}_{ᵢ}.

The importance of the functions B_{R}(ωᵢ,ω) and B_{I}(ωᵢ,ω) comes from the fact that they are the key for both the modulation and demodulation of the SSDM carrier. In fact, the spectrum of any SSDM subcarrier can be represented as a weighted combination of these functions as in 3. Therefore, recalling 2, the composite spectrum of the SSDM carrier is

$$S ( ω ) = {\sum }_{i = 1}^{N} \{ {A}_{{R}_{i}} {B}_{R} ( {ω}_{i} , ω ) + {jA}_{{I}_{i}} {B}_{I} ( {ω}_{i} , ω ) \} . \qquad ( 5 )$$

Eq. 5 defines the spectrum contribution of one subcarrier. This is the equation that should be considered when working with signals either in baseband or at any frequency. Nonetheless, this expression can be further simplified when the SSDM operates at higher frequencies, for instance in Intermediate Frequency (IF). The preferred embodiment of the inventor consists on using subcarrier frequencies starting at 40 MHz. For the means of this disclosure, it is assumed that the transmission and reception elements contain an up-converter and a down-converter correspondingly. As it is seen below, working on IF reduces the complexity of the apparatus. Working on IF is feasible but it only involves higher sampling rates at the D/A and A/D converters. The amount of operations involved on the computation remain the same and depend only on the sampling frequency and number of sub-carriers.

The functions in 4 can be further simplified by making the subcarrier frequencies fᵢ considerably bigger than the symbol frequency 1/T and by focusing the analysis only in the positive side of these functions. fᵢ represents the distance of the main loop to the axis f=0. Meanwhile, 1/T is the width of the main loop. The relationship between fᵢ and 1/T in IF determines how close is the carrier from base-band axis. By making

fᵢ>>1/T, (6)

or equivalently ωᵢT>>1, the main loop of the spectral function becomes considerably apart from the base-band axis. This makes the second term of the basis functions in 4 negligible in the parts of the spectrum within the main loop which is nearby ωᵢ. In consequence, it reduces the expression of the angle of the spectral function ∠Sᵢ(ω) to a constant φᵢ.

In this sense, the second term of Eqs. 4 is reduced to

$${lim}_{{ω}_{i} T \to ∞} \frac{sin [ ( {ω}_{i} + ω ) T / 2 ]}{{ω}_{i} + ω} = 0$$

### and Eqs. 4 to

$${B}_{R} ( {ω}_{i} , ω ) = {B}_{I} ( {ω}_{i} , ω ) = \frac{sin [ ( {ω}_{i} - ω ) T / 2 ]}{{ω}_{i} - ω} \qquad ( 7 )$$

for ω>0. Therefore, Eq. 5 is reduced to

$$\begin{matrix}{lim}_{{ω}_{i} T \to ∞} S ( ω ) = {\sum }_{i = 1}^{N} \{ {A}_{{R}_{i}} \frac{sin [ ( {ω}_{i} - ω ) T / 2 ]}{{ω}_{i} - ω} + j {A}_{{I}_{i}} \frac{sin [ ( {ω}_{i} - ω ) T / 2 ]}{{ω}_{i} - ω} \} \\ = {\sum }_{i = 1}^{N} ( {A}_{{R}_{i}} + {jA}_{{I}_{i}} ) \frac{sin [ ( {ω}_{i} - ω ) T / 2 ]}{{ω}_{i} - ω} \\ = {\sum }_{i = 1}^{N} {Q}_{i} \frac{sin [ ( {ω}_{i} - ω ) T / 2 ]}{{ω}_{i} - ω} .\end{matrix} \qquad ( 8 )$$

where Qᵢ is the modulating QAM complex constant Qᵢ=Aᵢe^{jφ}^{ᵢ} such that |Qᵢ|=Aᵢ and ∠Qᵢ=φᵢ. The resultant spectral components of the individual subcarriers are

$${S}_{i} ( ω ) = {Q}_{i} \frac{sin [ ( {ω}_{i} - ω ) T / 2 ]}{{ω}_{i} - ω} .$$

The related spectral components are shown in Table 0.1.

TABLE 0.1
Components of an SSDM subcarrier spectra

| | | | |
|---|---|---|---|
| \|Sᵢ (ω)\| | ∠Sᵢ (ω) | [symbol] {Sᵢ (ω)} | [symbol] {Sᵢ (ω)} |
| ${A}_{i} \frac{sin [ ( {ω}_{i} - ω ) T / 2 ]}{{ω}_{i} - ω}$ | φᵢ | ${A}_{{R}_{i}} \frac{sin [ ( {ω}_{i} - ω ) T / 2 ]}{{ω}_{i} - ω}$ | ${A}_{{I}_{i}} \frac{sin [ ( {ω}_{i} - ω ) T / 2 ]}{{ω}_{i} - ω}$ |

| | |
|---|---|
| (a) Magnitude and phase | (b) Real and imaginary |

The assumption of that ωᵢT>>1 is consistent with systems currently used in the practice. For instance, in the worst case scenario, a carrier at a frequency as low as 600 MHz as used in WiMax may have a symbol period as small as 3.2 μs as used in WiFi which results in ωᵢT=12×10³. Different from other systems, this assumption forces the digital signal processing to take place not in baseband but in intermediate frequency. The existence of fast A/D converters in the market facilitates this task and allows omitting low pass filters and often the entire up or down converting stages. The graphics included in this disclosure were obtained using a relationship of f₁T=128; being f₁ the frequency of the first SSDM subcarrier in intermediate frequency which was 40 MHz.

Continuous equations are used in analog circuits. However, for digital signal processing, discrete analysis is required. In this section, the continuous functions 8 and 5 are analyzed in a discrete form to develop the operations of both the SSDM transmitter and receiver. These equations are supported with matrix examples.

The number of samples that comprises one SSDM symbol is a countable real number equal to Tf_{S} where f_{S} is the sampling frequency. Let t be a multidimensional vector made of tₖ=kTₛ for every k in {−Tf_{S}/2, −Tf_{S}/2+1, . . . , Tf_{S}/2−1}. Similarly, in the frequency domain, let f be a multidimensional vector such as fₖ=k/T. Hereafter, vectors are represented in bold s and matrices with an added bar s̅.

Thus, taking Eq. 1, s̅[tₖ]=Σᵢ₌₁^{N} sᵢ[tₖ] where sᵢ[tₖ]=Σ_{k=-Tf}_{_{S}}_{/2}^{Tf}^{_{S}}^{/2-1}Aᵢ cos(2πfᵢtₖ+φᵢ). Similarly, Eqs. 2 and 8 become

$$\begin{matrix}\overline{S} [ {f}_{k} ] = {\sum }_{i = 1}^{N} {S}_{i} [ {f}_{k} ] & ( 9 ) \\ where & \\ {S}_{i} [ {f}_{k} ] = {\sum }_{k = - {Tf}_{S} / 2}^{{Tf}_{S} / 2 - 1} {Q}_{i} \frac{sin [ π ( {f}_{i} - {f}_{k} ) T ]}{2 π ( {f}_{i} - {f}_{k} )} & ( 10 ) \\ for {f}_{k} > 0 and {f}_{i} ≫ 1 / T . & \\ Let & \\ {R}_{i}^{′} [ {f}_{k} ] = {\sum }_{k = - {Tf}_{S} / 2}^{{Tf}_{S} / 2 - 1} \frac{sin [ π ( {f}_{i} - {f}_{k} ) T ]}{2 π ( {f}_{i} - {f}_{k} )} . & ( 11 )\end{matrix}$$

Therefore, Sᵢ[fₖ]=QᵢR′ᵢ[fₖ].

### Matrix Example for Formula Derivation

Let an SSDM system with 3 subcarriers be the example. The subcarriers are named a, b and c and have frequencies fₐ, f_{b} and f_{c}. The SSDM carrier is generated as follows in Table 0.2.

TABLE 0.2
SSDM modulation in the time domain

| Normalized subcarrier | | |
|---|---|---|
| pulse components of | | |
| length T in the time | | Transmitted signal in the |
| domain | Modulated subcarriers in the time domain | time domain |
| c_{a:} sin (2πfₐt), cos (2πfₐt) | sₐ (tₖ) = Aₐ_{_{R}} cos (2πfₐt) − Aₐ_{_{I}} sin (2πfₐt) | s(tₖ) = sₐ (tₖ) + s_{b} (tₖ) + s_{c} (tₖ) |
| c_{b:} sin (2πf_{b}t), cos (2πf_{b}t) | s_{b} (tₖ) = A_{b}_{_{R}} cos (2πf_{b}t) − A_{b}_{_{I}} sin (2πf_{b}t) | |
| c_{c:} sin (2πf_{c}t), cos (2πf_{c}t) | s_{c} (tₖ) = A_{c}_{_{R}} cos (2πf_{c}t) − A_{c}_{_{I}} sin (2πf_{c}t) | |

The frequency representation of the SSDM carrier is S(fₖ)=Sₐ(fₖ)+S_{b}(fₖ)+S_{c}(fₖ). By expanding the real part of Eq. 9 (the subindex R denotes the real part),

S_{Ra}(fₖ)=A_{Ra}[ . . . S_{Ra}(fₖ₋₁)S_{Ra}(fₖ)S_{Ra}(fₖ₊₁) . . . ]

S_{Rb}(fₖ)=A_{Rb}[ . . . S_{Rb}(fₖ₋₁)S_{Rb}(fₖ)S_{Rb}(fₖ₊₁) . . . ]

S_{Rc}(fₖ)=A_{Rc}[ . . . S_{Rc}(fₖ₋₁)S_{Rc}(fₖ)S_{Rc}(fₖ₊₁) . . . ]

that is equivalent to

S_{Rb}(fₖ)=[ . . . A_{Ra}·S_{Ra}(fₖ₋₁)A_{Ra}·S_{Ra}(fₖ)A_{Ra}·S_{Ra}(fₖ₊₁) . . . ]

S_{Rb}(fₖ)=[ . . . A_{Rb}·S_{Rb}(fₖ₋₁₎A_{Rb}·S_{Rb}(fₖ)A_{Rb}·S_{Rb}(fₖ₊₁) . . . ]

S_{Rc}(fₖ)=[ . . . A_{Rc}·S_{Rc}(fₖ₋₁)A_{Rc}·S_{Rc}(fₖ)A_{Rc}·S_{Rc}(fₖ₊₁) . . . ]

By adding this vectors together and transposing them,

$$[ \begin{matrix}⋮ \\ {S}_{R} ( {f}_{k + 1} ) \\ {S}_{R} ( {f}_{k} ) \\ {S}_{R} ( {f}_{k - 1} ) \\ ⋮\end{matrix} ] = [ \begin{matrix}⋮ \\ {A}_{Ra} \cdot {S}_{Ra} ( {f}_{k + 1} ) - {A}_{Rb} \cdot {S}_{Rb} ( {f}_{k + 1} ) + {A}_{Rc} \cdot {S}_{Rc} ( {f}_{k + 1} ) \\ {A}_{Ra} \cdot {S}_{Ra} ( {f}_{k} ) + {A}_{Rb} \cdot {S}_{Rb} ( {f}_{k} ) + {A}_{Rc} \cdot {S}_{Rc} ( {f}_{k} ) \\ {A}_{Ra} \cdot {S}_{Ra} ( {f}_{k - 1} ) - {A}_{Rb} \cdot {S}_{Rb} ( {f}_{k - 1} ) + {A}_{Rc} \cdot {S}_{Rc} ( {f}_{k - 1} ) \\ ⋮\end{matrix} ]$$

which can be expressed as a matrix by vector multiplication as

$$[ \begin{matrix}⋮ \\ {S}_{R} ( {f}_{k + 1} ) \\ {S}_{R} ( {f}_{k} ) \\ {S}_{R} ( {f}_{k - 1} ) \\ ⋮\end{matrix} ] = [ \begin{matrix}⋮ & ⋮ & ⋮ \\ {S}_{Ra} ( {f}_{k + 1} ) & {S}_{Rb} ( {f}_{k + 1} ) & {S}_{Rc} ( {f}_{k + 1} ) \\ {S}_{Ra} ( {f}_{k} ) & {S}_{Rb} ( {f}_{k} ) & {S}_{Rc} ( {f}_{k} ) \\ {S}_{Ra} ( {f}_{k - 1} ) & {S}_{Rb} ( {f}_{k - 1} ) & {S}_{Rc} ( {f}_{k - 1} ) \\ ⋮ & ⋮ & ⋮\end{matrix} ] \cdot [ \begin{matrix}{A}_{Ra} \\ {A}_{Rb} \\ {A}_{Rc}\end{matrix} ] . \qquad ( 12 )$$

Letting this expression be χ_{R}=Γ_{R}×Λ_{R} is convenient because:
χ_{R} corresponds to the spectrum of the SSDM carrier.
The columns in the matrix Γ_{R} contain the spectral form of one subcarrier each. Accordingly, this matrix has N columns.
Λ_{R} contains the real part of the modulating symbols Qᵢ.

The analysis of the imaginary part is no different, therefore, χ_{I}=Γ_{I}×Λ_{I}. Additionally, it is known as seen in Eqs. 7 and 8 that Γ_{R}=Γ_{I}=Γ. Therefore, the complete answer χ=χ_{R}+jχ_{I}=Γ×Λ_{R}+jΓ×Λ_{I}=Γ×(Λ_{R}+jΛ_{I}). However,

$${Λ}_{R} + j {Λ}_{I} = [ \begin{matrix}{Q}_{a} \\ {Q}_{b} \\ {Q}_{c}\end{matrix} ] = Λ .$$

As a consequence,

χ=Γ̅×Λ (13)

where χ=S[fₖ] represents the SSDM carrier and Γ, called the projection matrix, corresponds to a normalized matrix of spectral shapes with (1+j) R′ᵢ[fₖ] in every column as defined in Eq. 11. It can be shown by reversing Eq. 8 that the base function that corresponds to Rᵢ[fₖ]=(1+j) R′ᵢ[fₖ] in the time domain is rᵢ(t)=cos(2πfᵢt+π/4). This is

$$\overline{Γ} [ {f}_{k} ] = [ \begin{matrix}\overbrace{[ \begin{matrix}⋮ \\ ( 1 + j ) \frac{sin [ π ( {f}_{1} - {f}_{k} ) T ]}{2 π ( {f}_{1} - {f}_{k} )} \\ ⋮\end{matrix} ]}^{{\{ {R}_{1} ( {f}_{k} ) \}}_{k = - {Tf}_{S} / 2}^{{Tf}_{S} / 2 - 1}} & \overbrace{[ \begin{matrix}⋮ \\ ( 1 + j ) \frac{sin [ π ( {f}_{2} - {f}_{k} ) T ]}{2 π ( {f}_{2} - {f}_{k} )} \\ ⋮\end{matrix} ]}^{{\{ {R}_{2} ( {f}_{k} ) \}}_{k = - {Tf}_{S} / 2}^{{Tf}_{S} / 2 - 1}} & …\end{matrix} ] . \qquad ( 14 )$$

With this, the SSDM carrier for this example can be also generated in the frequency domain as shown in Table 0.3.

TABLE 0.3
SSDM modulation in the frequency domain

| Normalized subcarrier | | Subcarrier signals | | |
|---|---|---|---|---|
| pulses of length T in | Spectrum of the | modulated in the | | Transmitted signal |
| time domain | subcarrier signals | frequency domain | SSDM carrier spectrum | in the time domain |
| rₐ (t) = cos (2πfₐt + π/4) | F{rₐ(t)} = Rₐ (f) | Sₐ(f) = Qₐ · Rₐ(f) | S(f) = Sₐ(f) + S_{b}(f) + S_{c}(f) | F⁻¹{S(f)} = s(t) |
| r_{b} (t) = cos (2πf_{b}t + π/4) | F{r_{b}(t)} = R_{b}(f) | S_{b}(f) = Q_{b} · R_{b}(f) | | |
| r_{c} (t) = cos (2πf_{c}t + π/4) | F{r_{c}(t)} = R_{c}(f) | S_{c}(f) = Q_{c} · R_{c}(f) | | |

Eq. 13 determines the relationship between the modulating constants Λ and the composite spectrum χ. On the other hand, the opposite relationship can be derived directly. Eq. 13 can be written like

$$[ S [ {f}_{k} ] ] = [ \begin{matrix}{R}_{a} [ {f}_{k} ] \\ {R}_{b} [ {f}_{k} ] \\ {R}_{c} [ {f}_{k} ]\end{matrix} ] \times [ \begin{matrix}{Q}_{a} \\ {Q}_{b} \\ {Q}_{c}\end{matrix} ] .$$

Although the length of the vectors S and R is T/T_{S}, only N elements are required for decoding. Therefore, by selecting arbitrarily N rows from χ and Γ̅, Γ̅ becomes square and this expression can be reversed to

$$\begin{matrix}[ \begin{matrix}{Q}_{a} \\ {Q}_{b} \\ {Q}_{c}\end{matrix} ] = {[ \begin{matrix}{R}_{a} [ {f}_{k} ] \\ {R}_{b} [ {f}_{k} ] \\ {R}_{c} [ {f}_{k} ]\end{matrix} ]}^{- 1} \times [ S [ {f}_{k} ] ] , & ( 15 ) \\ therefore , & \\ {Λ}^{′} = {\overline{Γ}}^{- 1} \times {χ}^{′} & \end{matrix}$$

where χ′ represents the spectrum of the received signal s′(t), Γ⁻¹ the inverse of the normalized functions matrix and Λ′ a vector with the received symbols Q′ᵢ. The inverse matrix Γ⁻¹ can be calculated off-line and be hardcoded at the receiver.

The selection of the N rows to use is a matter of convenience. In principle, the center frequencies of the carriers are preferred. However, this selection is independent from fᵢ and could vary depending on the application.

This synthesized formula of SSDM is seemingly simple when compared other detectors seen in prior art, at the expense of longer FFT blocks and higher sampling rates. The length of the FFT blocks however does not result on an exponential factor as only a few input or output samples, depending on the case, need to be computed. The SSDM the detector comprises of one matrix by vector multiplication of order

$${[ ⋱ ]}_{N \times N} \times {[ ⋮ ]}_{N \times 1} .$$

Similarly, the FFT blocks do not need to be complete. Only N outputs are necessary leaving the implementation to discretion of the use of Sparse Discrete Fourier Transform blocks. Finally, if the subcarrier frequencies remain constant, the most complex operations can be performed off-line and be hardcoded in both the transmitter and the receiver.

More details of the Sparse Discrete Fourier Transform can be seen in Appendix A.

In another aspect, the analysis for Sub-carriers with non standard pulse shapes would proceed similar. For example, the projection matrix can be developed for a SSDM system with both Hanning-windowed pulses and heterogeneous sub-carrier spacing. The use of non standard RF pulses or windowing could have many applications: detect signals that are shifted from the expected frequency, increase the density of the subcarriers where the channel seems favorable, randomize the carrier for security purposes, reducing external interference or correcting distortion.

In this sense, in an embodiment, the spectral function in Eq. 3 on page 18 can be replicated if a Hanning window h(t) is applied to the transmitted signal. In that case:

$$s ( t ) = \{ \begin{matrix}A cos ( {ω}_{0} t + φ ) & - T / 2 \leq t \leq T / 2 \\ 0 & otherwise\end{matrix} \\ h ( t ) = \{ \begin{matrix}\frac{1}{2} cos ( \frac{2 π t}{T} ) + \frac{1}{2} & - T / 2 \leq t \leq T / 2 \\ 0 & otherwise\end{matrix} .$$

Let

$${ω}_{s} = \frac{2 π}{T}$$

be the frequency of the symbols, and A_{R}=A cos φ and A_{R}=A sin φ the real and imaginary components of Ae^{jφ}. The Fourier transform of s(t)·h(t) is [symbol] {s(t)·h(t)}=S_{H}(ω). Therefore, the spectral function for a subcarrier with frequency ω₀ is:

$$\begin{matrix}{S}_{H} ( ω ) = {\int }_{- ∞}^{∞} s ( t ) \cdot h ( t ) {e}^{- j ω t} dt \\ = {\int }_{- T / 2}^{T / 2} A cos ( {ω}_{0} t + φ ) ( \frac{1}{2} cos {ω}_{s} t + \frac{1}{2} ) {e}^{- j ω t} dt \\ = \frac{A}{8} {e}^{j φ} {\int }_{- T / 2}^{T / 2} ( 2 {e}^{j {ω}_{0} t} + {e}^{j ( {ω}_{0} - {ω}_{s} ) t} + {e}^{j ( {ω}_{0} + {ω}_{s} ) t} ) {e}^{- j ω t} dt + \\ \frac{A}{8} {e}^{- j φ} {\int }_{- T / 2}^{T / 2} ( 2 {e}^{- j {ω}_{0} t} + {e}^{- j ( {ω}_{0} - {ω}_{s} ) t} + {e}^{- j ( {ω}_{0} + {ω}_{s} ) t} ) {e}^{- j ω t} dt \\ = \frac{{A}_{R}}{4} \cdot ( 2 \frac{sin [ ( {ω}_{0} - ω ) T / 2 ]}{{ω}_{0} - ω} + \frac{sin [ ( {ω}_{0} - {ω}_{s} - ω ) T / 2 ]}{{ω}_{0} - {ω}_{s} - ω} + \\ \frac{sin [ ( {ω}_{0} + {ω}_{s} - ω ) T / 2 ]}{{ω}_{0} + {ω}_{s} - ω} … + 2 \frac{sin [ ( {ω}_{0} + ω ) T / 2 ]}{{ω}_{0} + ω} + \\ \frac{sin [ ( {ω}_{0} - {ω}_{s} + ω ) T / 2 ]}{{ω}_{0} - {ω}_{s} + ω} + \frac{sin [ ( {ω}_{0} + {ω}_{s} + ω ) T / 2 ]}{{ω}_{0} + {ω}_{s} + ω} ) + \\ j \frac{{A}_{I}}{4} \cdot ( 2 \frac{sin [ ( {ω}_{0} - ω ) T / 2 ]}{{ω}_{0} - ω} + \frac{sin [ ( {ω}_{0} - {ω}_{s} - ω ) T / 2 ]}{{ω}_{0} - {ω}_{s} - ω} + \\ \frac{sin [ ( {ω}_{0} + {ω}_{s} - ω ) T / 2 ]}{{ω}_{0} + {ω}_{s} - ω} … - 2 \frac{sin [ ( {ω}_{0} + ω ) T / 2 ]}{{ω}_{0} + ω} - \\ \frac{sin [ ( {ω}_{0} - {ω}_{s} + ω ) T / 2 ]}{{ω}_{0} - {ω}_{s} + ω} - \frac{sin [ ( {ω}_{0} + {ω}_{s} + ω ) T / 2 ]}{{ω}_{0} + {ω}_{s} + ω} ) .\end{matrix}$$

Therefore, S_{H}(ω₀,ω) in general is:

$$⇒ {S}_{H} ( {ω}_{0} , ω ) = {A}_{R} [ {B}_{A} ( {ω}_{0} , ω ) + {B}_{B} ( {ω}_{0} , ω ) ] + {jA}_{I} [ {B}_{A} ( {ω}_{0} , ω ) - {B}_{B} ( {ω}_{0} , ω ) ]$$

$$where$$

$${B}_{A} ( {ω}_{i} , ω ) = 2 \frac{sin [ ( {ω}_{i} - ω ) T / 2 ]}{{ω}_{i} - ω} + \frac{sin [ ( {ω}_{i} - {ω}_{s} - ω ) T / 2 ]}{{ω}_{i} - {ω}_{s} - ω} + \frac{sin [ ( {ω}_{i} + {ω}_{s} - ω ) T / 2 ]}{{ω}_{i} + {ω}_{s} - ω}$$

$${B}_{B} ( {ω}_{i} , ω ) = 2 \frac{sin [ ( {ω}_{i} + ω ) T / 2 ]}{{ω}_{i} + ω} + \frac{sin [ ( {ω}_{i} - {ω}_{s} + ω ) T / 2 ]}{{ω}_{i} - {ω}_{s} + ω} + \frac{sin [ ( {ω}_{i} + {ω}_{s} + ω ) T / 2 ]}{{ω}_{i} + {ω}_{s} + ω} .$$

With this, the projection matrix used in [43] can be calculated similar than in Eq. 14 on page 25:

$$\overline{Γ} [ {f}_{k} ] = [ \begin{matrix}{\{ {S}_{H} ( {f}_{1} , {f}_{k} ) \}}_{k = - {Tf}_{S} / 2}^{{Tf}_{S} / 2 - 1} & & {\{ {S}_{H} ( {f}_{N} , {f}_{k} ) \}}_{k = - {Tf}_{S} / 2}^{{Tf}_{S} / 2 - 1} \\ \overbrace{[ \begin{matrix}⋮ \\ ⋮ \\ ⋮\end{matrix} ]} & … & \overbrace{[ \begin{matrix}⋮ \\ ⋮ \\ ⋮\end{matrix} ]}\end{matrix} ] .$$

After the selection of N rows, Γ can be used at the SSDM receiver using Eq. 15 on page 26.

In another embodiment the SSDM system Heterogeneous sub-carriers frequencies, the previous analysis is restricted to homogeneous carriers spacing. For this is necessary to define α=1 as the normal separation between carriers in the case of OFDM. From there, heterogenous spacing means that Δf=α/T is constant. Meanwhile, in SSDM the frequency step factor Δfᵢ can be arbitrary and heterogeneous from one subcarrier to another.

In essence, nothing has to change to generate either heterogeneous or homogeneous subcarriers as long as the receiver knows the modulating frequencies fᵢ. Other carrier parameters in the detector, such as Γ, T, f_{S}, require to be adjusted to match the transmitter's. In a certain embodiment, an SSDM system could have the first two subcarriers being, even only one spectral sample apart, α_{1⇄2}=a, depending of the system parameters meanwhile the average separation could be α_{avg}=b. In general, even subcarrier distributions have better BER performance than heterogeneous subcarriers spacing.

Two corrective mechanisms are disclosed. These methods bring dramatic improvement to multi-carrier receivers with overlapped carriers.

### Advantages

Transmission signals can be generated digitally via direct playback of samples, a FFT unit or analog QAM modulation of sub-carriers signal generators. Detection is performed in a straight forward way by multiplying a reduced amount of samples from a Fourier transform block with a matrix. The minimum dimension of the vectors and the matrix equals the number of sub-carriers. The dimension of the projection matrix can grow for increased accuracy.

The invention provides flexibility to accommodate sub-carriers at any place in the frequency domain. Spectrally Efficient multi-carriers and OFDM carriers affected by the Doppler effect can be decoded by the SSDM apparatus.

The SSDM method provides flexibility per individual sub-carrier. At the receiver, independent equalization can be performed to the rows of the projection matrix.

If no independent equalization is being performed, and the frequency and forms of the sub-carriers remain constant during the transmission, all the constants can be computed off-line and hardcoded at the apparatus.

The CM and the ILR reduction bring dramatic improvements to the signal reception while keeping flexibility.

Other systems such as OFDM, SEFDM and OvFDM are all homogeneous and have no flexibility toward sub-carrier shifting, the use of a different pulse pattern or the Doppler effect. Meanwhile SSDM is flexible and, with proper configuration, can operate under those conditions alone or combined.

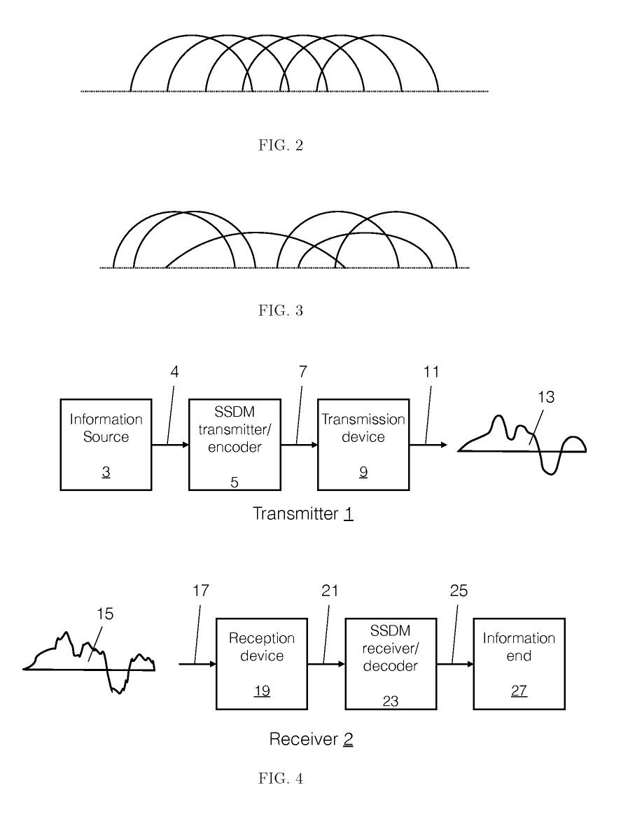

### Detailed Description FIG. 2 and FIG. 3

The arrangement in FIG. 2 and FIG. 3 show an exemplary arrangement of preferred embodiments for SSDM multi-carrier signals both homogeneous and non-homogenous respectively. In FIG. 2, one sees a plurality of sub-carriers that are depicting uniform amplitude sinusoidal or modulated square signal carriers. The sub-carriers in FIG. 2 are overlapped beyond the point of orthogonality and are considered an Spectrally Efficient carrier. In FIG. 3, an alternative embodiment with non homogeneous sub-carrier signals is shown. The sub-carrier signals correspond to a SSDM system in which each sub-carrier has arbitrary center frequency and different pulse patterns. The sub-carriers could be, for instance, windowed or broadened with an spreading code, or simply compressed for amplitude limitation, among other realizations.

### SSDM System—FIG. 4

The information from an information source [3] is transmitted to the SSDM encoder [5] via connection [4]. [5] receives a stream of bits and delivers a series of samples in Pulse Coded Modulation (PCM) that represent the signal of the symbol to be transmitted through the SSDM transmission system [1]. A connection [7] passes this signal to a transmission device [9]. In an embodiment, [9] comprises of an up-converter, a band pass filter and an amplifier. The signal is transmitted from [9] by a signal transducer [11] to a medium, for instance a conductor or the air. The transmitted SSDM carrier [13] represents the SSDM multi-carrier signal sent to the medium.

On the SSDM reception system [2], the noisy received SSDM carrier [15] is passed by reception transducer [17] in analog form to a reception device [19]. [19] takes the signal to the desired levels and frequency, for instance either IF or base-band. The connection [21] passes the signal to the SSDM decoder [23] which converts the received symbol [15] to bits. These bits are passed by connection [25] to the information sink [27].

### Operation SSDM Receiver—FIG. 5

The SSDM receiver consists of an optional down-converter, an ADC, a tracking block that removes the CP, a serial to parallel converter, a fast Fourier transform (FFT) block, a detection stage, a classifier and a bit assembler.

The complex form of Eq. 12 is

$$[ \begin{matrix}⋮ \\ S ( {f}_{k + 1} ) \\ S ( {f}_{k} ) \\ S ( {f}_{k - 1} ) \\ ⋮\end{matrix} ] = [ \begin{matrix}⋮ & ⋮ & … & ⋮ \\ {S}_{1} ( {f}_{k + 1} ) & {S}_{2} ( {f}_{k + 1} ) & & {S}_{N} ( {f}_{k + 1} ) \\ {S}_{1} ( {f}_{k} ) & {S}_{2} ( {f}_{k} ) & ⋱ & {S}_{N} ( {f}_{k} ) \\ {S}_{1} ( {f}_{k - 1} ) & {S}_{2} ( {f}_{k - 1} ) & & {S}_{N} ( {f}_{k - 1} ) \\ ⋮ & ⋮ & … & ⋮\end{matrix} ] \cdot [ \begin{matrix}{Q}_{1} \\ {Q}_{2} \\ ⋮ \\ {Q}_{N}\end{matrix} ] \qquad ( 16 )$$

which is equivalent to Eq. 13. To make this equation invertible, only N rows are used. By doing this, the modulating constants Qᵢ can be estimated at the receiver as shown in Eq. 15.

An approach to calculate Γ⁻¹ is using Eq. 14. For this, Γ needs to be square. Therefore, Γ⁻¹ is calculated using only the N rows that contain the fₖ of interest. The frequencies selected are the ones that match the N samples at the output of the FFT block. Let the N samples be fₐ, f_{b} to f_{Z} respectively. Meanwhile, f₁ to f_{N} are the frequencies of the SSDM subcarriers; in other words, constants. Therefore, Γ⁻¹ can be obtained from

$$\overline{Γ} [ {f}_{k} ] = [ \overbrace{[ \begin{matrix}⋮ \\ ( 1 + j ) \frac{sin [ π ( {f}_{1} - {f}_{k} ) T ]}{2 π ( {f}_{1} - {f}_{k} )} \\ ⋮\end{matrix} ]}^{{\{ {R}_{1} ( {f}_{k} ) \}}_{k = \{ {k}_{a} , {k}_{b} , … , {k}_{m} \}}} \overbrace{[ \begin{matrix}⋮ \\ ( 1 + j ) \frac{sin [ π ( {f}_{2} - {f}_{k} ) T ]}{2 π ( {f}_{2} - {f}_{k} )} \\ ⋮\end{matrix} ]}^{{\{ {R}_{2} ( {f}_{k} ) \}}_{k = \{ {k}_{a} , {k}_{b} , … , {k}_{m} \}}} … ]$$

which is equal to

$$\overline{Γ} [ {f}_{k} ] = [ \begin{matrix}( 1 + j ) \frac{sin [ π ( {f}_{1} - {f}_{a} ) T ]}{2 π ( {f}_{1} - {f}_{a} )} \\ ( 1 + j ) \frac{sin [ π ( {f}_{1} - {f}_{b} ) T ]}{2 π ( {f}_{1} - {f}_{b} )} \\ ⋮\end{matrix} \begin{matrix}( 1 + j ) \frac{sin [ π ( {f}_{2} - {f}_{a} ) T ]}{2 π ( {f}_{2} - {f}_{a} )} & … & ⋮ \\ ( 1 + j ) \frac{sin [ π ( {f}_{2} - {f}_{b} ) T ]}{2 π ( {f}_{2} - {f}_{b} )} & ⋱ & ⋮ \\ ⋮ & … & ( 1 + j ) \frac{sin [ π ( {f}_{N} - {f}_{Z} ) T ]}{2 π ( {f}_{N} - {f}_{Z} )}\end{matrix} ] .$$

The estimated symbols at the receiver are then

$$[ \begin{matrix}{Q}_{a}^{′} \\ {Q}_{b}^{′} \\ ⋮ \\ {Q}_{m}^{′}\end{matrix} ] = {\overline{Γ}}^{- 1} [ {f}_{k} ] \cdot [ \begin{matrix}{S}^{′} ( {f}_{a} ) \\ {S}^{′} ( {f}_{b} ) \\ ⋮ \\ {S}^{′} ( {f}_{m} )\end{matrix} ]$$

where Q′ᵢ is the estimated value of Qᵢ and S′(f) corresponds to the spectrum of the received signal taken from N outputs of the FFT block. The N samples selected correspond to the frequencies of interest. This frequencies are preferably the center frequencies of the subcarriers. Otherwise, the frequencies available at the output of the FFT block are {−f_{S}/2, −f_{S}/2+1/T, . . . , f_{S}/2−1/T} in correspondence to their respective k's which are {−Tf_{S}/2, −Tf_{S}/2+1, . . . , Tf_{S}/2−1} through the relationship fₖ=k/T. High k's should be selected to satisfy the assumption made in Eq. 10.

The FFT block has T/αT_{S} inputs and same amount of outputs. The selection of the desired samples is not necessarily related to the ones that match every subcarrier fᵢ. The use of FFT blocks is possible by adjusting the size of the symbol so the amount of inputs to the block is 2^{r} where r is an integer. This adjustment can be done by zero padding the received signal. Otherwise, a DFT block can be used. Besides that, the required sampling frequency is inversely proportional to the space between subcarriers and directly proportional to the symbol length. This is fₛ∝α⁻¹ and f_{S}∝T. Similarly, the number of complex multiplications depends on N² and the number of complex additions on (N−1)N.

An embodiment for the SSDM receiver is shown in FIG. 5 which is susceptible of improvement with the correction methods shown later. In this receiver, the signal is converted into digital form with an ADC. A tracking block detects the beginning of the signal period and removes the CP. A serial to parallel converter delivers the symbol to an FFT block. The FFT block provides N samples to the detection stage. The estimated symbols are then classified and placed in serial form to the information end.

The preferred embodiment SSDM Receiver [30] comprises of a reception unit [31] connected by a connection [32] to an Analog to Digital Converter [33]. The digitized signal is passed along by a connection [34] to a Tracking Unit [35]. [35] performs removal of the cyclic prefix/postfix that might be present according to system parameters. The remaining signal represents the received symbol. This symbol is passed by a connection [36] to a Serial to Parallel converter [37]. [37] feeds a Sparse FFT block [41] by a connection [38]. Two padding blocks [39] complete the desired size of the Fourier transform. Not all the output of [41] is computed but only, preferably, N complex values carried in the form of a vector by a connection [42], being N the number of sub-carriers on the system. These values are multiplied with the data in memory Projection Matrix [43] transmitted as a matrix by a connection [44] and multiplied by a Matrix-Vector multiplier [45]. The result of the complex multiplication is N complex values transmitted as a vector by a connection [46] to a sub-carrier classifier [47]. [47] maps every value present in [46] into independent constellations according to the design of the system. The detector [56] is grouped with [47] to form a unit detector and classifier [55]. These blocks are grouped for convenience since later the CM method disclosed operates within [56] while the ILR method involves all the blocks inside [55]. The output of the classifier is groups of bits according to the classified symbols. These groups of bits are passed by a connection [50] to a bit assembler [51] which outputs data to a connection [52] to finally deliver the same to the information end [53].

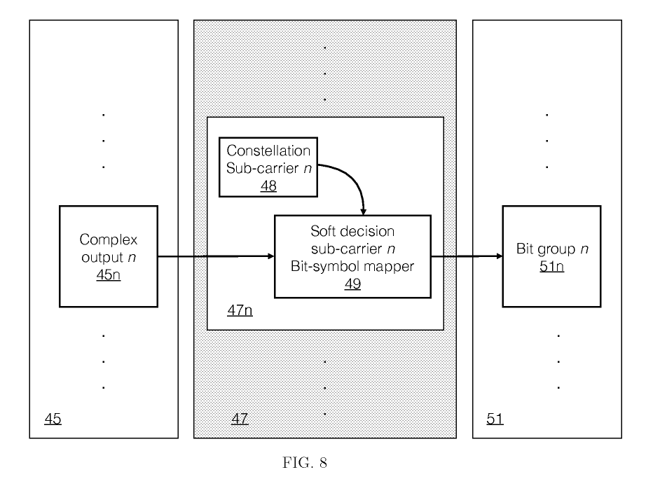

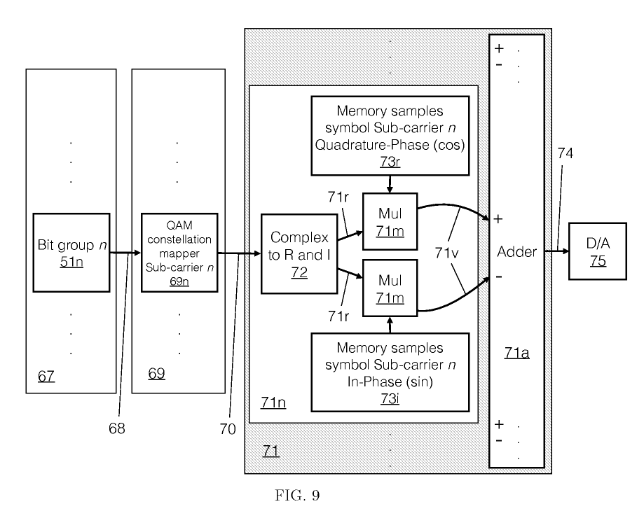

More details of [47] are shown in an embodiment in FIG. 8 which is an embodiment for detection of a single sub-carrier. From [45] a complex value [45n] is obtained corresponding to a certain subcarrier n. This value is taken to a soft-decision classifier for sub-carrier n [49] which computes the closest match form the constellation map which data is available in memory at the Constellation Sub-carrier n block [48]. The classifier [49] then outputs the bits corresponding to the constellation point estimated from sub-carrier n.

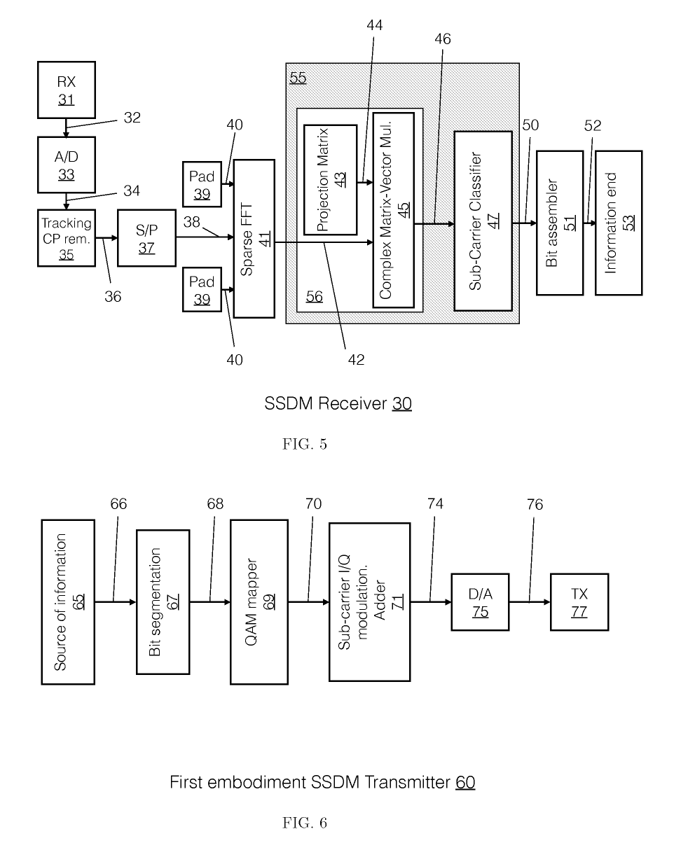

### Description Preferred Embodiment—FIG. 6

The embodiment in FIG. 6 comprises of a source of information [65]. A connection [66] carries bits to a bit segmentation block [67]. Groups of bits are transmitted by a connection [68] to a QAM mapper [69]. In an embodiment, [69] can have different constellations for each sub-carrier. The output of [69] in the form of a complex vector is transmitted by a connection [79] to a Sub-carrier I/Q modulation and adder unit [71]. The output of [71] is a sequence of samples representing the SSDM carrier. A connection [74] delivers the data to a D/A converter [75] which is then transmitted by a connection [76] to a transmission device [77]. The signal present in [76] is in either baseband or, for best results, in IF.

Details of the preferred embodiment appear in FIG. 9. A group of bits have been already segmented and are represented by the bit group n [51n] form [67]. A constellation map corresponding to such sub-carrier [69n] inside the memory of [69] is used to select a point from the constellation accordingly to later perform quadrature amplitude modulation. The signal generation aggregated for sub-carrier n is has two components that are computed by the signal generator n [71n] within [71]. The complex value received by the connection [70] is split into real and imaginary by the Complex to R and I block [72]. Each value performs amplitude modulation of the signals forms stored in Memory samples symbol Sub-carrier n blocks [73r] and [73i]. [73r] holds the cosine form of the pattern whether a modified tone or not. [73i] holds the sine form of the pattern similarly. The resulting samples are transmitted by the connections [71v] in the form of vectors to be added (and subtracted) by the adder module [71a]. [71a] aggregates all the signals form the subcarriers. The resultant signal is then transmitted by [74] to [75].

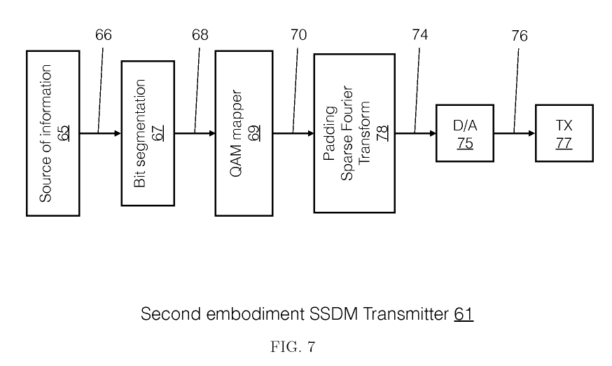

### Alternative Embodiment—FIG. 7

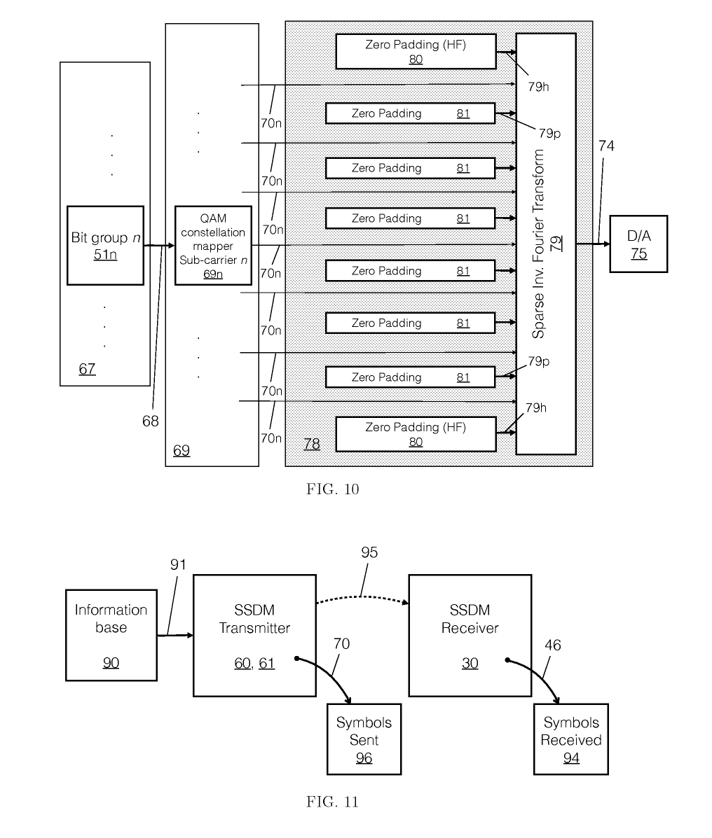

The embodiment is similar than the one in FIG. 6 except for [71]. In place of [71] there is a Padding and Sparse Fourier Transform block [78]. In this embodiment, [78] modulates a sinusoidal tone with every complex value received from [69] in a very similar manner than OFDM does. The difference is that [78] comprises of padding stages [81] that provide sub-carrier overlapping as detailed in FIG. 10. The complex values from [69] are spread into the locations corresponding to the frequencies of interest across a Sparse Inverse Fourier Transform unit [79].

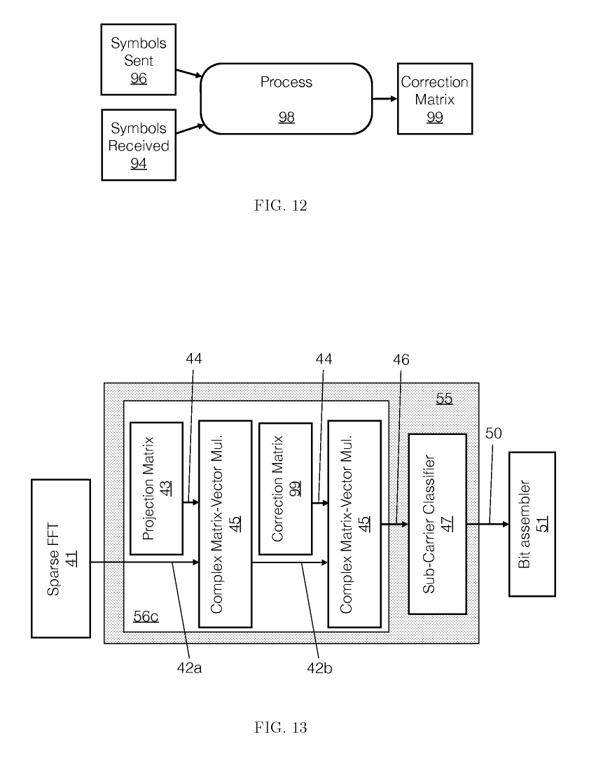

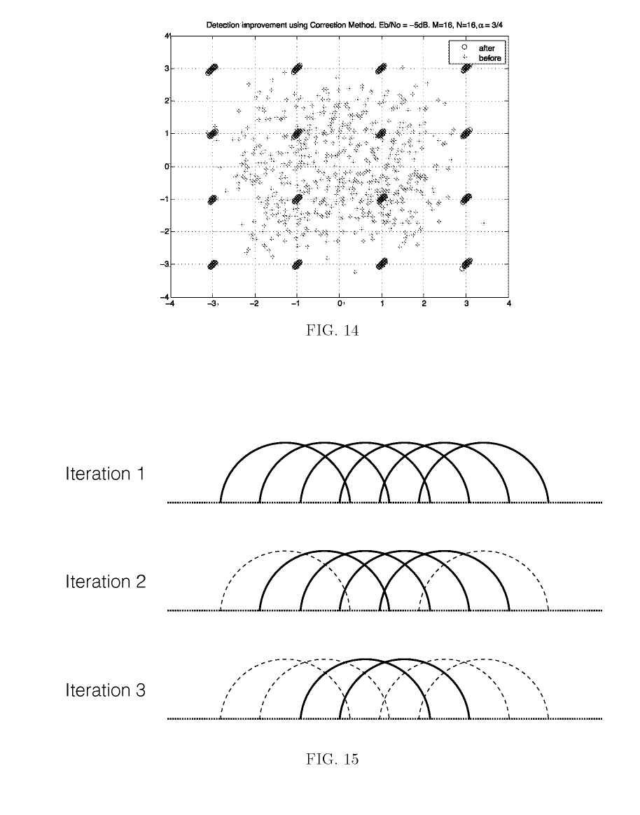

### FIG. 11, FIG. 12 and FIG. 13—Correction Method (CM)

FIG. 11 shows an embodiment to generate data for subsequent processing to obtain a correction matrix. The symbol base [90] preferably consists of information to ensure the transmission of all the combination of all the possible symbols, once time each, to be transmitted by the certain SSDM system. These symbols are transmitted by [60] (or [61]), one by one, via the medium [95]. [95] happens to have, or has been calibrated with, a certain fixed signal to noise ratio, for which the Correction Matrix will be generated.

As shown in FIG. 11, the method requires to store, preferable all, of the complex values of the corresponding symbols transmitted by the a transmitter [60] (or [61]). Similarly, the method requires to store the corresponding complex values at the output of the detector [56] of the a receiver [30]. The best places to grab these values at the transmitter and the receiver are the connection [70] and the connection [46] respectively. In an aspect, these values must be in vector form. In another aspect, the results of each symbol transmitted are stored in one line of a matrix, forming like this two matrices—the Symbols Sent [96] matrix and the Symbols Received [94] matrix. After this, both of these matrices are populated of complex values.

As shown in FIG. 12, in another aspect, the Symbols Sent [96] are used along with the Symbols Received [94] to perform a certain Process [98] obtain a Correction Matrix [99].

The correction method (CM) relies in a correction matrix computed under certain process, under certain system conditions and depends on system parameters. The information needed to obtain a correction matrix [99] is a complex matrix of symbols sent [96] and a complex matrix of symbols received [94]. In one embodiment, [99] can be computed by the following formula:

C=(R′×R)⁻¹×(R′×T) (17)

where C is the correction matrix which complex values are to be stored in the Correction Matrix unit [99], R is the matrix with the received symbols and T is the matrix with the received symbols, taken from connections [70] and [46] as shown in FIG. 11. The notation R′ means R transposed, and (X)⁻¹ the inverse matrix of X.

As depicted in FIG. 13, in an embodiment, the Correction Matrix [99] is used in the SSDM detector [56c], which is an improvement to the SSDM detector [56] incorporating the benefit of the correction matrix method. In this embodiment, an additional matrix to vector multiplication [45] affects symbols detected by the detector in [45] before they are classified at a sub-carrier classifier [47].

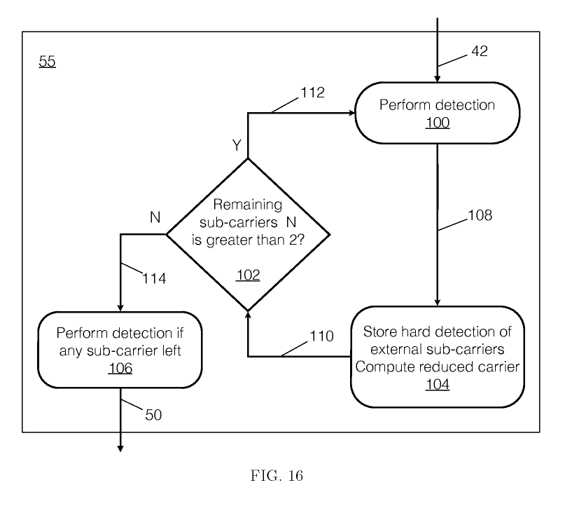

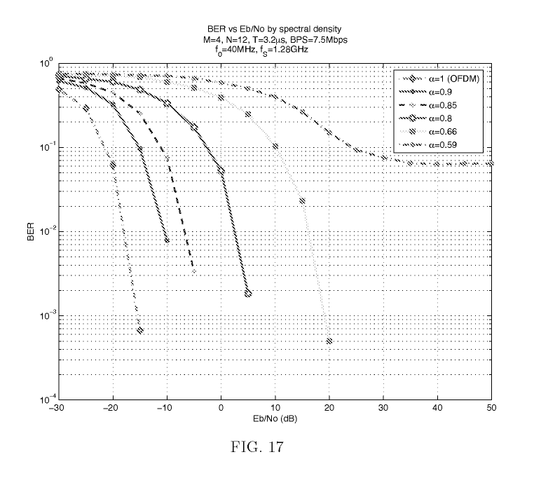

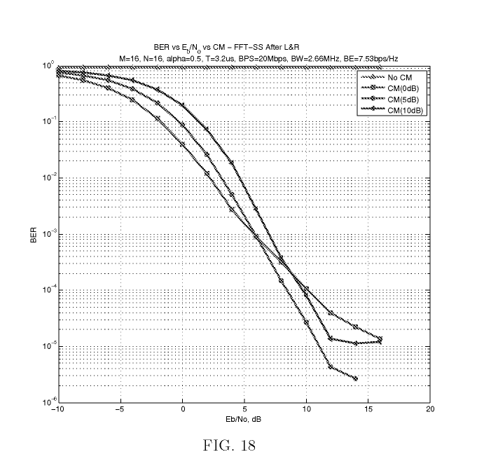

FIG. 14 depicts the effects of applying a the correction matrix on a certain receiver, in this embodiment the CM was calibrated with an SSDM system at

$$\frac{{E}_{b}}{{N}_{0}} = - 5 dB .$$

In this example, also the SE carrier is of the order of 16-subcarriers and each sub-carrier is of the order of 16-QAM. Similarly, the normalized separation between subcarriers is α=¾. It is seen in FIG. 14 how, at the low SNR in this example, the symbols are received with greater performance.

On another aspect, shows results of the combination of methods ILR with CM for an SSDM embodiment with 16 sub-carriers, order of 16-QAM each, and normalized sub-carrier separation of α=½. The curve labeled ‘No CM’ corresponds to the BER at different SNRs. It can be seen that when the CM is not being used, symbol detection is impossible as the BER approaches to 1—even using the ILR method. On the other hand, the curves labeled ‘CM(0 dB)’, ‘CM(5 dB)’ and ‘CM(10 dB)’ show the BER at different SNRs when a correction matrix has been applied. The curves with square, circle and left-arrow markers corresponds to results with correction matrices calibrated by the CM at

$$\frac{{E}_{b}}{{N}_{0}}$$

of 0 dB, 5 dB and 10 dB correspondingly. Analyzing data like the one shown on in will help making a thoughtful selection of the desired calibration of the correction matrix for a specific embodiment. Finally, the required sets of C can be computed off-line and be pre-loaded in the system.

In one embodiment, only the critical correction matrix can be computed. This matrix being the one that brings the receptor BER curve to the left, or down, or to the area of interest, according to FIG. 18. In this embodiment only a set of correction matrices could be computed and stored in the controller [55] to be pulled to [99] according to the size and settings of the multi-carrier signal.

In another embodiment, more sets of correction matrices could be available for different levels of noise to signal ratio.

### FIG. 16, FIG. 15—Iterative Lock & Repeat Method (ILR)

The ILR method involves both the detector [56] and the classifier [47], together the ILR subsystem [55]. This [55] is a control module that is capable of changing the dimension of the projection matrix stored in [43], the size of the complex multiplication taking place at [45] and of controlling the sub-carriers being classified at [47]. The method starts from receiving the data from connection [42]. From there, connection [42] is temporarily disconnected as [55] performs the ILR process. As depicted in FIG. 16, the ILR process consists of detecting symbols from subcarriers with [56], classifying the result of only the two external sub-carriers with [47], storing the result and mathematically creating a new virtual multi-carrier with [104], repeating the process. When the last one or two carriers is detected and classified at [106], the result is completed and transmitted to connection [50]. At this point [42] can be reconnected (or stop being ignored) to the multiplier. In every iteration of the loop, the entire [55] is reconfigured to process a multi-carrier that is now 2 sub-carriers smaller. FIG. 15 depicts the sub-carriers being detected by [55] in each iteration.

The ILR method can be combined with the CM. In the case of combining both the ILR and the CM, [56] is replaced by [56c] and [42] by [42a]. Moreover, being N the number of sub-carriers in the system, a correction matrix of dimension N will be necessary for the first iteration, of dimension N−2 for the second and so. These matrices have to be calibrated for the same noise level.

Note that to take full advantage of the detector as well as of each of the correction methods, proper magnitude estimation is required at the reception device [19] so that the signal is normalized for the following units. Another point of magnitude escalation could be after the first matrix multiplications take place at [45].

In one embodiment, in which both of the correction methods is used together, the computation of the reduced virtual sub-carrier is computed by

$$[ \begin{matrix}{\hat{a}}_{i} \\ ⋮ \\ {\hat{a}}_{N - i}\end{matrix} ] = {[ \begin{matrix}{c}_{i} ( {f}_{i} ) & … & {c}_{N - i} ( {f}_{i} ) \\ ⋮ & ⋱ & ⋮ \\ {c}_{i} ( {f}_{N - i} ) & … & {c}_{N - i} ( {f}_{N - i} )\end{matrix} ]}^{- 1} ( [ \begin{matrix}{r}_{i} \\ ⋮ \\ {r}_{N - i}\end{matrix} ] - [ \begin{matrix}[ {c}_{1} ( {f}_{i} ) … {c}_{i - 1} ( {f}_{i} ) ] & [ {c}_{N - i + 1} ( {f}_{i} ) … {c}_{N} ( {f}_{i} ) ] \\ ⋮ & ⋮ \\ [ {c}_{1} ( {f}_{N - i} ) … {c}_{i - 1} ( {f}_{N - i} ) ] & [ {c}_{N - i + 1} ( {f}_{N - i} ) … {c}_{N} ( {f}_{N - i} ) ]\end{matrix} ] [ \begin{matrix}\overbrace{\underbrace{\begin{matrix}{a}_{1} \\ ⋮ \\ {a}_{i - 1}\end{matrix}}} \\ \overbrace{\underbrace{\begin{matrix}{a}_{N - i - 1} \\ ⋮ \\ {a}_{N}\end{matrix}}}\end{matrix} ] ) \qquad ( 18 )$$

where i=1 . . . N, N is the number of sub-carriers, â in the left are the new virtual sub-carrier values and a are all the subcarriers that have been already detected and classified by [55]. At the first iteration, a would be comprised only of the classified values of the first and the last sub-carriers and would be of length 2. Meanwhile, at the same first iteration, â would be of length N−2. At every iteration â is reduced and a grows. r, on the other hand, is all the values that have been detected. r is fresh new in every iteration since the values of â are being fed to the detector [56] (or [56c]) each time. Meanwhile, c is the projection matrix.

For convenience, the marks [symbol] and [symbol] next to the . . . in 18 mean that in every iteration such dimension either grows or gets smaller correspondingly.

Although in Eq. 18 the letter c denotes carrier, and all the values are complex, the notation is equivalent to the one in Eq. 16 or Eq. 12, in which S can be replaced by c). Finally, all the matrices with values of c are subsets of c. cᵢ(fᵢ) is the value of the projection matrix corresponding to frequency fᵢ.

Eq. 18 is in the form of, for a certain iteration, U_{â}=K_{Pc1}×(Uᵣ−K_{Pc2}×Uₐ) where U stands for unknown, K for known and P stands for partial. All the values of K can be computed off-line. K_{Pc1} is square and is the inverse of a square subset of the projection matrix Γ, it is lead toward the center of the matrix. K_{Pc2} is not square but it contains the values of K missing in K_{Pc1} in subgroups. As an example, this would be the first iteration when computing the inner sub-carriers of a multi-carrier of N=4:

$$[ \begin{matrix}{a}_{2} \\ {a}_{3}\end{matrix} ] = [ \begin{matrix}{c}_{2} ( {f}_{2} ) & {c}_{3} ( {f}_{2} ) \\ {c}_{2} ( {f}_{3} ) & {c}_{3} ( {f}_{3} )\end{matrix} ] {x}^{- 1} ( [ \begin{matrix}{r}_{2} \\ {r}_{3}\end{matrix} ] - [ [ \begin{matrix}{c}_{1} ( {f}_{2} ) \\ {c}_{2} ( {f}_{3} )\end{matrix} ] [ \begin{matrix}{c}_{4} ( {f}_{2} ) \\ {c}_{4} ( {f}_{3} )\end{matrix} ] ] [ \begin{matrix}{a}_{1} \\ {a}_{4}\end{matrix} ] ) .$$

### APPENDIX A

Although the user can select an optimized Fast Fourier Transform for the punctual application, the Sparse Fourier transforms can be easily computed directly from the general formula of the form of the Discrete Fourier Transform (DFT) is given by

$${X}_{k} = {\sum }_{n = 0}^{N - 1} {x}_{n} \cdot {e}^{- j 2 π \frac{k}{N} n} .$$

Where a regular DFT block calculates all the possible Xₖ, the FrDFT does only m of the Xₖ. The selected Xₖ correspond to the m spectral samples of interest. k is then restricted to {k₁, . . . , kₘ}. Adapted to SE receivers, these expressions become S[fᵢ]=Σ_{k′=-Tf}_{_{S}}_{/2}^{Tf}^{_{S}}^{/2-1}s[t_{k′}]·e^{-j2πf}^{ᵢ} where t_{k′}=k′Tₛ and fᵢ every element in {−f_{S}/2, −f_{S}/2+1/T, . . . , f_{S}/2−1/T}. Where a regular DFT block calculates S[fᵢ] for every possible fᵢ, the FrDFT does only for N of the fᵢ. The fᵢ selected correspond to the spectral samples of interest. This is, {S[fₐ], S[f_{b}], . . . , S[f_{z}]}.

Similarly, the Sparse Inverse Discrete Fourier Transform (IFrDFT) can be computed from the general formula of the direct form of the Inverse Discrete Fourier Transform (IDFT) is given by

$${x}_{n} = \frac{1}{N} {\sum }_{k = 0}^{N - 1} {X}_{k} {e}^{i 2 {π }^{{k}_{1}} / N n} . \qquad ( 19 )$$

What, for the SSDM transmitter, becomes s[t]=Σ_{k=-Tf}_{_{S}}_{/2}^{Tf}^{_{S}}^{/2-1}S[fₖ]·e^{-j2πf}^{ₖ} where fₖ is every element in {−f_{S}/2, −f_{S}/2+1/T, . . . , f_{S}/2−1/T}. Coming back to the general form, a regular IDFT block calculates each xₙ using all the possible k. However, the IFrDFT block calculates each xₙ using only m elements from k. The selected k correspond to the modulating inputs (no padding) of the block. Where the regular DFT calculates every possible kᵢ, the FrDFT does only for N of the kᵢ. This is, {kₐ, k_{b}, . . . , k_{z}}. This replaces 19 for

$${x}_{n} = \frac{1}{N} ( {X}_{k} {e}^{i 2 {π }^{{k}_{1}} / N n} + … + {X}_{k} {e}^{i 2 {π }^{{k}_{m}} / N n} ) .$$

Apart from this, for an output xₙ_{₁}_{, n}_{₂}_{, . . . . , n}_{_{d}} consisting of real data, the input vector shall have a conjugate symmetry Xₖ_{₁}_{, k}_{₂}_{, . . . , k}_{ₘ}=X*_{N-k}_{₁}_{, N-k}_{₂}_{, . . . , N-k}_{ₘ}. Therefore, an output element of the IFrDFT is

$${x}_{n} = \frac{1}{N} ( {X}_{{k}_{1}} {e}^{i 2 {π }^{{k}_{1}} / N n} + {X}_{{k}_{1}}^{*} {e}^{i 2 {π }^{N - {k}_{1}} / N n} + … + {X}_{{k}_{m}} {e}^{i 2 {π }^{{k}_{m}} / N n} + {X}_{{k}_{m}}^{*} {e}^{i 2 {π }^{N - {k}_{m}} / N n} ) .$$

Adapted to SE receivers, these expressions become

$$s [ t ] = \frac{1}{{Tf}_{S}} {\sum }_{{k}^{′} = - {Tf}_{S / 2}}^{{Tf}_{S / 2} - 1} S [ {f}_{{k}^{′}} ] .$$

e^{j2πf}^{ₖ}′ from which not all the k′ are used but only the ones associated to the frequencies of interest {fₐ, f_{b}, . . . , f_{z}}. Therefore, this expression becomes

$$s [ t ] = \frac{1}{{Tf}_{S}} ( S [ {f}_{a} ] {e}^{j 2 π {f}_{a}} + {S}^{*} [ {f}_{a} ] {e}^{j 2 π {f}_{a}} + … + S [ {f}_{m} ] {e}^{j 2 π {f}_{m}} + {S}^{*} [ {f}_{m} ] {e}^{j 2 π {f}_{m}} ) .$$

### APPENDIX B

The spectral efficiency (SE) is calculated based on the used bandwidth and the carrier speed. Just as, the bandwidth is computed based on the dimension of the carrier N, the bits of the constellations k, the carrier separation α and the symbol period T. Both the bandwidth (BW) and the effective spectral efficiency can be calculated by:

$$BW = \frac{( N - 1 ) α + 2}{T} \\ ESE {=}^{Δ} \frac{k \cdot N ( 1 - BER )}{BW \cdot T} \qquad ( 20 )$$

The effective spectral efficiency (ESE) is defined as the number of non-error bits sent per unit of spectrum. This indicator provides a more reliable and complete indicator of performance of a communication system than the BER. ESE tests have shown than SSDM has higher SE than OFDM and other SEFDM methods.

1. A multi-carrier communications system for communicating a plurality of signals comprising a transmitting device with a transmitting antennae, a communications channel and a receiving device with a receiving antenna, wherein, in some of the antennae, said signals are separated by either equal frequency steps or arbitrary frequency steps or a combination of both, wherein said signals are further based on either sinusoidal tones or custom pulses or a combination of both.

2. The system of claim 1, wherein said signals are modulated sub-carriers forming a spectrally efficient system characterized by overlapped tones that are arranged at frequency steps, either equal or different, that are a certain fraction of orthogonal steps.

3. The system of claim 1 wherein said signals are modulated sub-carriers forming an OFDM system characterized by orthogonal tones that are arranged at frequency steps that are orthogonal.

4. The system of claim 1 wherein the properties of an interfering signal from a surrounding carrier that overlaps with a number of said multi-carrier signals at said receiving end, are used to re-configure a receiver at said receiving end to decouple the interference by demodulating said signals as if said interfering signal were an additional carrier of said system.

5. The system of claim 1 wherein said signals are modulated sub-carriers customized in either center frequency or pulse shape or a combination of both to either: overcome problems at the communication channel; or, compensate for lack of linearity on amplifiers.

6. The system of claim 1 wherein said signals are customized in either center frequency or signal shape or a combination of both for privacy purposes whereas said signal shapes can further change from time to time in a cooperative manner between the transmitter and the receiver of said system.

7. The system of claim 1 wherein 1 or more of said signals is spread whereas its separation step could be zero hertz if using orthogonal spreading patterns.

8. The system of claim 1 wherein said receiving device independently equalizes incoming signals from more than 1 transmitting device.

9. (canceled)

10. A transmitter of spectrally efficient signals, wherein said signals are modulated forming a spectrally efficient system characterized by overlapped tones that are arranged at frequency steps that are a certain fraction of orthogonal steps, whereas the transmitted signals carry multiple symbols, whereas the transmitter comprises:
means for dividing information into independent groups of bits; means for mapping each group of bits into a complex number, such as in QAM;
an inverse Fourier transform block wherein some inputs are used to input said complex numbers, wherein the remaining inputs are physically or logically padded with zeroes, whereas the amount of padding both between and on the sides of said complex number inputs plus of said inverse Fourier transform block define the digital frequency of the first sub-carrier signal the amount of overlapping between the output signals as well as the sampling frequency of the output signal;
means for transmitting the resulting signal, optionally using an up-converter or a D/A converter.

11. A receiver of Spectral Shape Division Multiplexing signals comprising:
means for tracking and receiving a multi-carrier signal such as in OFDM;
means for down converting the signal if required;
means for removing an optional cyclic prefix or postfix;
means to sample the signal at a certain sampling frequency;
a Fourier transform block wherein the inputs are used to input said sampled signal, whereas optional symmetric padding on the sides of said sampled signal at the inputs of said Fourier transform block can be used to increase precision, whereas a number of elements is used from its complex output of said Fourier transform block, whereas said number is at least the number of sub-carriers of said multi-carrier signal;
means for computing a Projection Matrix based on the parameters of the SSDM system, the number of samples and relative digital frequency expected at the output signal of said Fourier transform block and the pulse shape of each sub-carrier signal;
means for multiplying a vector, or group of numbers, formed by said number of complex elements at the output of said Fourier transform block with said Projection Matrix obtaining a complex vector made of estimated symbols as a result of said matrix-vector multiplication;
means for classifying those symbols according to a map such as in QAM;
means for mapping said classified symbols into groups of bits;
means to interleave said groups of bits to an information end.

12. The receiver of claim 11 wherein said Projection Matrix is computed considering equalization, or amplification distortion, or both, on each sub-carrier or all sub-carriers.

13. The receiver of claim 11 wherein said Projection Matrix has been computed off-line.

14. The receiver of claim 11 wherein said Projection Matrix has been computed considering the Doppler effect or said signals are located at non-orthogonal frequencies.

15. The receiver of claim 11 wherein said Projection Matrix has been computed based on signals that are separated by either equal frequency steps or arbitrary frequency steps or a combination of both, wherein said signals are further based on either sinusoidal tones or custom pulses or a combination of both.

16. The receiver of claim 11 wherein said detected signals are periodic signals, incoming from a source, tried to be matched with a combination of the signal patterns used to compute the projection matrix.

17. The receiver of claim 11 wherein said receiver comprises a correction stage that reduces the error of said estimated complex symbols, whereas said correction stage comprises computing a complex correction matrix, multiplying it by said complex estimated symbols, whereas said correction stage outputs corrected estimated symbols in the form of complex data to the input of said means for classifying symbols.

18. The receiver of claim 17 wherein said complex correction matrix has been computed off-line.

19. The receiver of claim 11 wherein said receiver comprises an iterative stage for overlapped multi-carrier reduction that operates based on said estimated symbols, whereas said iterative stage commands a process of iterative reduction comprising:
(a) classifying the first and the last symbols, corresponding to the sub-carriers with the lower and the higher frequencies, using said means for classifying symbols;
(b) re-computing the remaining symbols with means to mathematically subtract the recently classified symbols from the group of said estimated symbols;
(c) classifying the newly computed first and the last symbols, corresponding to the sub-carriers with the newly lower and higher frequencies, using said means for classifying symbols;
(d) repeating steps (b) to (c) until all sub-carriers have been classified.

20. The receiver of claim 17 wherein said receiver comprises an iterative stage for overlapped multi-carrier reduction that operates based on said corrected estimated symbols, whereas said iterative stage commands a process of iterative reduction of the carrier comprising:
(a) classifying the first and the last symbols, corresponding to the sub-carriers with the lowest and the highest frequencies, using said means for classifying symbols;
(b) re-computing the remaining symbols with means to mathematically subtract the recently classified symbols from the group of said estimated symbols, wherein the result of newly computed symbols is corrected by another correction matrix that is adjusted to the number of the newly computed symbols;
(c) classifying the newly computed first and the last symbols, corresponding to the sub-carriers with the newly lower and higher frequencies, using said means for classifying symbols;
(d) repeating steps (b) to (c) until all sub-carriers have been classified.

21-26. (canceled)
